(19) United States
(12) Patent Application Publication
(10) Pub. No.: US 2017/0192916 A1
(43) Pub. Date: Jul. 6, 2017

(54) AUTOMATIC USB IDENTIFICATION AND COMMUNICATION SYSTEM WITH STAR ARCHITECTURE AND METHOD THEREOF

(71) Applicant: SHENZHEN FLY-ORANGE TECHNOLOGY CO., LTD, Shenzhen, Guangdong (CN)

(72) Inventor: Yawei LUO, Songzi, Hubei province (CN)

(73) Assignee: SHENZHEN FLY-ORANGE TECHNOLOGY CO., LTD, Shenzhen, Guangdong province (CN)

(21) Appl. No.: 15/111,837

(22) PCT Filed: Mar. 31, 2014
(86) PCT No.: PCT/CN2014/074351

§ 371 Date: Oct. 9, 2016

(30) Foreign Application Priority Data
Jan. 15, 2014 (CN) 201410017637.1

(51) Int. Cl. G06F 13/362; G06F 13/38; G06F 13/42

(52) U.S. Cl. CPC G06F 13/362; G06F 13/4282; G06F 13/385

(57) ABSTRACT

Disclosed are an automatic USB identification and communication system with a star architecture and a method thereof. The automatic USB identification and communication system with a star architecture comprises a central control unit, an intermediate line, a master port, a slave port and a USB OTG port. The intermediate line is used for connecting the master port, the slave port and the USB OTG port. The central control unit is used for controlling the connection between the master port, the slave port and the USB OTG port. Automatic identification and communication of three types of devices with different USB properties are realized, and data exchange between the three types of devices with different USB properties is realized without continuously changing the data line.

### BACKGROUND OF THE INVENTION

Technical Field

The present invention relates to a USB-based information exchange technology, and more specifically, to an automatic USB identification and communication system with a star architecture and a method thereof.

2. Description of Related Art

With the popularity of smart phones and handheld tablet PCs in the market, the complete opening of USB OTG (OTG, short for On-the-Go and published during the USB Implementer Forum, is mainly used for connections between a variety of different devices or mobile devices for data exchange) port functions for both kinds of devices brings a higher demand for connections between smart phones or tablet PCs and slave devices, such as a USB mouse, USB keyboard, USB sound card and U disk.

The existing USB data lines or communication devices are all basically used to realize connections between any two master, slave and USB OTG devices with different USB properties, to conduct data communication or power transmission.

Once a PC or a laptop has to connect a single slave device, such as a USB mouse, USB keyboard, or U disk, it needs a conventional USB line for data and power transmission, and if it has to connect several slave devices, it needs conventional data lines or a USB hub.

For devices with USB OTG properties, such as smart phones or tablet PCs, which have to connect a slave device for data communication, special USB OTG transmission lines are needed for power transmission and data communication.

If data storage or exchange is to be conducted between the three types of devices with different USB properties, namely, master, slave and USB OTG device, at least two data lines are usually required; it seems inconvenient for users to carry two data lines, and the process become tedious during data exchange between the three types of devices.

### BRIEF SUMMARY OF THE INVENTION

In view of the disadvantages in the prior art, the present invention provides an automatic USB identification and communication system with a star architecture, via which automatic identification and communication of three types of devices with different USB properties are realized, and data exchange between the three types of devices with different USB properties is realized without continuously changing the data line.

To achieve the purposes above, the present invention adopts the following technical solution:

An automatic USB identification and communication system with a star architecture, comprising a central control unit, an intermediate line, a master port, a slave port and a USB OTG port, wherein the intermediate line is used for connecting the master port, the slave port and the USB OTG port, and the central control unit is used for controlling the connection between the master port, the slave port and the USB OTG port.

In another embodiment of the present invention, the intermediate line comprises a power supply circuit module, a data communication module and an OTG self-holding circuit module, wherein the power supply circuit module is used for circuit connection between the master port, the slave port, and the USB OTG port; the OTG self-holding circuit respectively connected to the central control unit and the USB OTG port is used to ensure power supply to the central control unit by the OTG device externally connected to the USB OTG port when the master port is not connected to the master, and the data communication module is used for communication between the master port, the slave port and the USB OTG port.

In another embodiment of the present invention, the master port is provided with a master power supply pin and a master data pin, with the slave port provided with a slave power supply pin and a slave data pin, and the USB OTG port provided with an OTG power supply pin, an OTG data pin and an OTG ID pin.

In another embodiment of the present invention, a first diode, a second diode, a capacitor, an operational amplifier, and a MOS transistor are arranged in the OTG self-holding circuit, wherein the MOS transistor is provided with a source electrode, a gate electrode, and a drain electrode, and the operational amplifier is provided with a non-inverting input end, an inverting input end, a positive power supply end, a negative power supply end and an output end; the source electrode of the MOS transistor connects the ground, with the gate electrode connected to the output end of the operational amplifier and the drain electrode connected to the OTG ID pin; the negative power supply end of the operational amplifier connects the ground, with its inverting input end connected to a constant reference voltage; the anode of the first diode connects the OTG power supply pin, with its cathode connected to the cathode of the second diode; the anode of the second diode connects the OTG ID pin, with its cathode connected to both the positive power supply end and the non-inverting input end of the operational amplifier; one end of the capacitor connects the ground, with the other end connected to the cathode of the second diode.

In another embodiment of the present invention, a first data analog switch, a second data analog switch, a third data analog switch and an OTG data detector are arranged in the data communication module, wherein the OTG data detector is used for testing the state of the OTG data pin and feeding back the test results to the central control unit, the first data analog switch is in series connection between the master data pin and the OTG data pin, with the second data analog switch serially connected between the OTG data pin and the slave data pin, and the third data analog switch serially connected between the master data pin and the slave data pin; the first data analog switch, the second data analog switch and the third data analog switch are under drive control by the central control unit.

In another embodiment of the present invention, a first power supply switch and a second power supply switch are arranged in the power supply circuit module, wherein the first power supply switch is in series connection between the master power supply pin and the OTG power supply pin, with the second power supply switch serially connected between the OTG power supply pin and the slave power supply pin; the first power supply switch and the second power supply switch are under drive control by the central control unit.

In another embodiment of the present invention, it is provided with several slave ports which are integrated together.

The present invention also provides a method for an automatic USB identification and communication system with a star architecture, including the following steps:

a. the master port, the slave port and the USB OTG port connect corresponding devices;

b. external devices supply power to the central control unit which tests the condition of connection between the master port and a master device, and between the USB OTG port and an OTG device, as well as conducting communication between any two of the master port, the slave port and the USB OTG port.

In Step b, the external master device directly supplies power to the central control unit, and the external OTG device supplies power to the central control unit via the OTG self-holding circuit module under the master mode; the central control unit determines the condition of connection between the master port and a master device as well as between the USB OTG port and an OTG device based on the tested potentials of the master power supply pin of the master port and the OTG ID pin of the USB OTG port, and the state of the OTG data pin, and controls the communication between the control power supply circuit module and the data communication module, and any two of the master port, the slave port and the USB OTG port; if the central control unit determines that the master port connects a master device and the USB OTG port connects an OTG device, the central control unit will connect the master port and the USB OTG port; if the central control unit determines that the master port connects a master device and the USB OTG port is not connected to an OTG device, the central control unit will connect the master port and the slave port; if the master port is not connected to a master device and the USB OTG port connects an OTG device, the OTG device will be shifted to the master mode via the OTG self-holding circuit and supply power to the central control unit; if the central control unit determines that the master port is not connected to a master device and the USB OTG port connects an OTG device, it will connect the USB OTG port and the slave port.

The present invention discloses an automatic USB identification and communication system with a star architecture and a method thereof, by which it supports data exchange between three types of devices with different USB properties and simplifies the process of data exchange between the three types of devices with different USB properties; via integration, the slave port can simultaneously support data exchange between a master device or an OTG device and several slave devices.

### BRIEF DESCRIPTION OF THE SEVERAL VIEWS OF THE DRAWINGS

FIG. 1 is a frame-structure diagram of the automatic USB identification and communication system with a star architecture of the present invention;

FIG. 2 is a structural diagram of the data communication module in the present invention;

FIG. 3 is a structural diagram of the power supply circuit module in the present invention;

FIG. 4 is a structural diagram of the automatic USB identification and communication system with a star architecture of the present invention;

FIG. 5 is a structural diagram of the OTG self-holding circuit in the present invention;

### DETAILED DESCRIPTION OF THE INVENTION

An automatic USB identification and communication system with a star architecture, comprising a central control unit, an intermediate line, a master port, a slave port and a USB OTG port, wherein the master port is used for connecting an external master device, the slave port is used for connecting an external slave device, the USB OTG port is used for connecting an OTG device, the intermediate line is used for connecting the master port, the slave port and the USB OTG port, and the central control unit is used for controlling the connection between the master port, the slave port and the USB OTG port, so as to realize data exchange between the master device, the slave device and the OTG device externally connected to the automatic USB identification and communication system with a star architecture.

In a bid to know more about characteristics and technical solutions of the present invention, the invention is further detailed in combination with the drawings as follows.

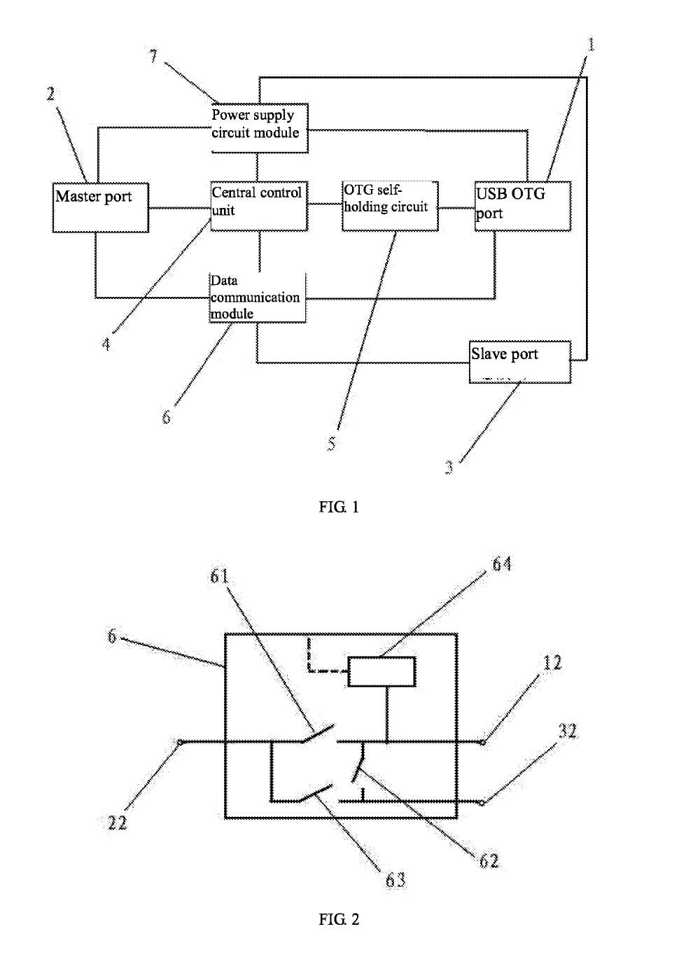

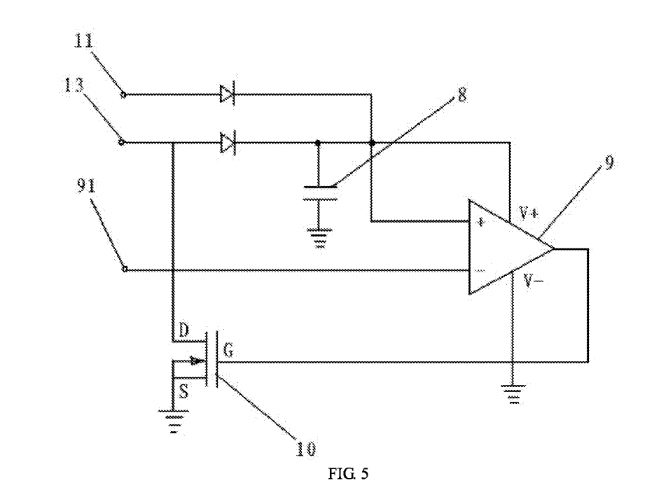

As shown in FIG. 1 and FIG. 4, the automatic USB identification and communication system with a star architecture comprises a master port 2, a slave port 3 and a USB OTG port 1, an intermediate line and a central control unit 4, wherein the intermediate line further comprises an OTG self-holding circuit module 5, a data communication module 6 and a power supply circuit module 7, and the central control unit comprises an identification detection module and a drive control module; the identification detection module is used for detecting the state, while the drive control module is used for controlling the data communication module 6 and the power supply circuit module 7.

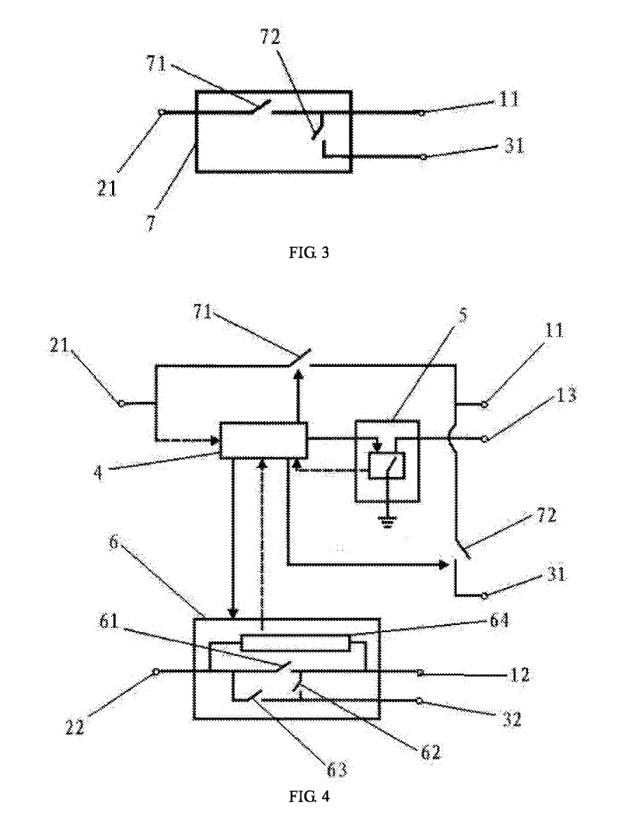

The master port 2 is used for connecting a master device, the slave port 3 is used for connecting a slave device, and the USB OTG port 1 is used for connecting an OTG device, wherein the master port 2 is provided with a master power supply pin 21 and a master data pin 22, with the slave port 3 provided with a slave power supply pin 31 and a slave data pin 32, and the USB OTG port 1 provided with an OTG power supply pin 11, an OTG data pin 12 and an OTG ID pin 13; the power supply circuit module 7 is used for communication between the OTG power supply pin 11, the master power supply pin 21 and the slave power supply pin 31; as shown in FIG. 3, a first power supply switch 71 and a second power supply switch 72 are arranged in the power supply circuit module 7, wherein the first power supply switch 71 is arranged between the master power supply pin 21 and the OTG power supply pin 11, with the second power supply switch 72 arranged between the OTG power supply pin 11 and the slave power supply pin 31.

The data communication module 6 is used for data communication between the master port, the slave port and the USB OTG port; as shown in FIG. 2, a first data analog switch 61, a second data analog switch 62, a third data analog switch 63 and an OTG data detector 64 are arranged in the data communication module 6, wherein the OTG data detector 64 is used for testing the state of the OTG data pin 12, namely, the condition of connection between the OTG data pin 12 and an OTG device, and feeding back the test results to the identification detection module of the central control unit 4; the first data analog switch 61 is in series connection between the master data pin 22 and the OTG data pin 12, for controlling the communication between the master data pin 22 and the OTG data pin 12, the second data analog switch 62 is in series connection between the slave data pin 32 and the OTG data pin 22, for controlling the communication between the slave data pin 32 and the OTG data pin 12, and the third data analog switch 63 is in series connection between the master data pin 22 and the slave data pin 32, for controlling the communication between the master data pin 22 and the slave data pin 32; the first power supply switch 71, the second power supply switch 72, the first data analog switch 61, the second data analog switch 62 and the third data analog switch 63 are all driven by the drive control module of the central control unit 4.

Respectively connected to the master port 2 and the USB OTG port 1, the identification detection module is used for testing the condition of connection between the master port 2 and a master device, and between the USB OTG port 1 and an OTG device, wherein the identification detection module determines the condition where the master device and the OTG device are connected into this system, based on the tested potentials of the master power supply pin 21 and the OTG ID pin 11 of the USB OTG port 1, and the state of the OTG data pin 12 tested by the OTG data detector 64.

As shown in FIG. 5, a first diode, a second diode, a capacitor 8, an operational amplifier 9, and a MOS transistor 10 are arranged in the OTG self-holding circuit, wherein the MOS transistor 10 is provided with a source electrode S, a gate electrode G, and a drain electrode D, and the operational amplifier 9 is provided with a non-inverting input end, an inverting input end, a positive power supply end, a negative power supply end and an output end; the source electrode S of the MOS transistor 10 connects the ground, with the gate electrode G connected to the output end of the operational amplifier 9 and the drain electrode D connected to the OTG ID pin 13; the negative power supply end of the operational amplifier 9 connects the ground, with its inverting input end connected to a constant reference voltage 91; the anode of the first diode connects the OTG power supply pin 11, with its cathode connected to the cathode of the second diode; the anode of the second diode connects the OTG ID pin 13, with its cathode connected to both the positive power supply end and the non-inverting input end of the operational amplifier 9; one end of the capacitor 8 connects the ground, with the other end connected to the cathode of the second diode.

The working principle of the OTG self-holding circuit is that: when the master port 2 is not connected to a master device, the USB OTG port 1 connects an OTG device, the central control unit 4 has no power, the original state of the OTG device is in a USB Device (slave) working mode, and the ID pin of the OTG device stays at a high potential; the OTG device provides weak power for the capacitor 8 via the OTG ID pin 13 of the USB OTG port 1 thus supplying power to the capacitor 8; when the voltage of the capacitor 8 reaches the reference voltage, the output end of the operational amplifier 9 outputs a voltage to the gate electrode G of the MOS transistor 10, with the drain electrode D of the MOS transistor 10 communicating with the source electrode S; the OTG ID pin 13 connects the ground, to pull down the potential, and the OTG device is shifted to the USB Host (master) working mode to supply power to this system in a low-potential state. When the master port 2 connects a master device, and the USB OTG port 1 connects an OTG device, the master device directly supplies power to this system, with the OTG self-holding circuit in the OFF state.

When the master port 2 connects a master device, the USB OTG port 1 connects an OTG device, and the slave port 3 is not connected to a slave device, the master device supplies power to this system; the identification detection module detects that the potential of the master power supply pin 21 remains high, and the OTG power supply pin 11 of the USB OTG port 1 stays at a high potential; the OTG data detector 64 detects the state of the OTG data pin 12 and feeds this back to the identification detection module for determining the connection condition of the master port 2 and the USB OTG port 1; the drive control module turns on the first power supply switch 71 and the first data analog switch 61, thus making the master device supply power to the OTG device, as well as keeping smooth communication between the master device and the OTG device, namely, a connection between the master port 2 and the USB OTG port 1.

When the master port 2 connects a master device, the USB OTG port 1 is not connected to an OTG device, and the slave port 3 connects a slave device, the master device supplies power to this system; the identification detection module detects the potentials of the master power supply pin 21 and the OTG power supply pin 11 of the USB OTG port 1; the OTG data detector 64 detects the state of the OTG data pin 12 and feeds this back to the identification detection module for determining that the master port 2 connects a master device and the USB OTG port 1 is not connected to an OTG device; the drive control module turns on the first power supply switch 71, the second power supply switch 72 and the third data analog switch 63, thus making the master device supply power to the slave device, as well as keeping smooth communication between the master device and the slave device, namely, a connection between the master port 2 and the slave port 1.

When the master port 2 connects a master device, the USB OTG port 1 connects an OTG device, and the slave port 3 connects a slave device, the master device supplies power to this system; the identification detection module detects the potentials of the master power supply pin 21 and the OTG power supply pin 11 of the USB OTG port 1; the OTG data detector 64 detects the state of the OTG data pin 12 and feeds back to the identification detection module for determining that the master port 2 connects a master device and the USB OTG port 1 connects an OTG device; the drive control module turns on the first power supply switch 71 and the first data analog switch 61, thus making the master device supply power to the OTG device, as well as keeping smooth communication between the master device and the OTG device, namely, a connection between the master port 2 and the USB OTG port 1.

When the master port 2 is not connected to a master device, the USB OTG port 1 connects an OTG device, and the slave port 3 connects a slave device, the OTG device supplies power to the system via the OTG self-holding circuit; the identification detection module detects the potentials of the master power supply pin 21 and the OTG power supply pin 11 of the USB OTG port 1; the OTG data detector 64 detects the state of the OTG data pin 12 and feeds back to the identification detection module for determining that the master port 2 is not connected to a master device and the USB OTG port 1 connects an OTG device; the drive control module turns on the second power supply switch 72 and the second data analog switch 62, thus making the OTG device supply power to the slave device, as well as keeping smooth communication between the OTG device and the slave device, namely, a connection between the slave port 3 and the USB OTG port 1.

When the system starts to run according to the connection condition of the master device, the slave device and the OTG device, once the potentials of the master power supply pin 21 of the master port 2 and the OTG power supply pin 11 of the USB OTG port 1, and the state of the OTG data pin 12 detected by the OTG data detector 64 have changed, the drive control module will cut off the first power supply switch 71, the second power supply 72, the first data analog switch 61, the second data analog switch 62 and the third data analog switch 63, and wait for 350 ms to 500 ms, the drive control module turns on the corresponding switches based on the foregoing conditions, according to the data tested by the identification detection module.

In the above embodiments, the automatic USB identification and communication system with a star architecture integrates several slave ports, to support the connection with several slave devices simultaneously.

The method of the automatic USB identification and communication includes the following steps:

a. the master port, the slave port and the USB OTG port connect corresponding devices;

b. external devices supply power to the central control unit which tests the condition of connection between the master port and a master device, and between the USB OTG port and an OTG device, as well as conducting communication between any two of the master port, the slave port and the USB OTG port.

In Step b, the external master device directly supplies power to the central control unit, and the external OTG device supplies power to the central control unit via the OTG self-holding circuit module under the master mode; the central control unit determines the condition of connection between the master port and a master device as well as between the USB OTG port and an OTG device based on the tested potentials of the master power supply pin of the master port and the OTG ID pin of the USB OTG port, and the state of the OTG data pin, and controls the power supply circuit module and the data communication module to communicate with any two of the master port, the slave port and the USB OTG port; if the central control unit determines that the master port connects a master device and the USB OTG port connects an OTG device, the central control unit will connect the master port and the USB OTG port; if the central control unit determines that the master port connects a master device and the USB OTG port is not connected to an OTG device, the central control unit will connect the master port and the slave port; if the master port is not connected to a master device and the USB OTG port connects an OTG device, the OTG device will be shifted to the master mode via the OTG self-holding circuit and supply power to the central control unit; if the central control unit determines that the master port is not connected to a master device and the USB OTG port connects an OTG device, it will connect the USB OTG port and the slave port.

After Step b, it also includes:

c. if the central control unit tests the potentials of the master power supply pin of the master port and the OTG ID pin of the USB OTG port, and the state of the OTG data pins have changed, the central control unit will cut off the connection between the master port, the slave port and the USB OTG port and wait for a while, and then return back to Step b.

In Step c, the first power supply switch and the second power supply switch in the power supply circuit module, as well as the first data analog switch, the second data analog switch and the third data analogy switch in the data communication module are cut off and wait for 350 ms to 500 ms, preferably, it waits for 350 ms to facilitate the central control unit to test the potentials of the master power supply pin of the master port and the OTG power supply pin of the USB OTG port.

The above embodiments are only used to describe but not intended to limit the present invention. Those skilled in this art can make corresponding modifications and adjustments without deviating from the principle of the present invention. However, all the modifications and adjustments should be covered in the protection scope of the Claims of the present invention.

1. An automatic USB identification and communication system with a star architecture, characterized in that, comprising a central control unit, an intermediate line, a master port, a slave port and a USB OTG port, wherein the intermediate line is used for connecting the master port, the slave port and the USB OTG port, and the central control unit is used for controlling the connection between the master port, the slave port and the USB OTG port.

2. The automatic USB identification and communication system with a star architecture as claimed in claim 1, characterized in that the intermediate line comprises a power supply circuit module, a data communication module and an OTG self-holding circuit module, wherein the power supply circuit module is used for circuit connection between the master port, the slave port, and the USB OTG port, the OTG self-holding circuit respectively connected to the central control unit and the USB OTG port is used to ensure power supply to the central control unit by the OTG device externally connected to the USB OTG port when the master port is not connected to the master, and the data communication module is used for communication between the master port, the slave port and the USB OTG port.

3. The automatic USB identification and communication system with a star architecture as claimed in claim 2, characterized in that the master port is provided with a master power supply pin and a master data pin, with the slave port provided with a slave power supply pin and a slave data pin, and the USB OTG port provided with an OTG power supply pin, an OTG data pin and an OTG ID pin.

4. The automatic USB identification and communication system with a star architecture as claimed in claim 3, characterized in that a first diode, a second diode, a capacitor, an operational amplifier, and a MOS transistor are arranged in the OTG self-holding circuit, wherein the MOS transistor is provided with a source electrode, a gate electrode, and a drain electrode, and the operational amplifier is provided with a non-inverting input end, an inverting input end, a positive power supply end, a negative power supply end and an output end; the source electrode of the MOS transistor connects the ground, with the gate electrode connected to the output end of the operational amplifier and the drain electrode connected to the OTG ID pin; the negative power supply end of the operational amplifier connects the ground, with its inverting input end connected to a constant reference voltage; the anode of the first diode connects the OTG power supply pin, with its cathode connected to the cathode of the second diode; the anode of the second diode connects the OTG ID pin, with its cathode connected to both the positive power supply end and the non-inverting input end of the operational amplifier; one end of the capacitor connects the ground, with the other end connected to the cathode of the second diode.

5. The automatic USB identification and communication system with a star architecture as claimed in claim 3, characterized in that a first data analog switch, a second data analog switch, a third data analog switch and an OTG data detector are arranged in the data communication module, wherein the OTG data detector is used for testing the state of the OTG data pin and feeding back the test results to the central control unit, the first data analog switch is in series connection between the master data pin and the OTG data pin, with the second data analog switch serially connected between the OTG data pin and the slave data pin, and the third data analog switch serially connected between the master data pin and the slave data pin; the first data analog switch, the second data analog switch and the third data analog switch are under drive control by the central control unit.

6. The automatic USB identification and communication system with a star architecture as claimed in claim 3, characterized in that a first power supply switch and a second power supply switch are arranged in the power supply circuit module, wherein the first power supply switch is in series connection between the master power supply pin and the OTG power supply pin, with the second power supply switch serially connected between the OTG power supply pin and the slave power supply pin; the first power supply switch and the second power supply switch are under drive control by the central control unit.

7. The automatic USB identification and communication system with a star architecture as claimed in claim 1, characterized in that it is provided with several slave ports which are integrated together.

8. A method of the automatic USB identification and communication system with a star architecture, characterized in that it includes the following steps:
a. the master port, the slave port and the USB OTG port connect corresponding devices;
b. external devices supply power to the central control unit which tests the condition of connection between the master port and a master device, and between the USB OTG port and an OTG device, as well as conducts communication between any two of the master port, the slave port and the USB OTG port.

9. The method of the automatic USB identification and communication system with a star architecture as claimed in claim 8, characterized in that, in Step b, the external master device directly supplies power to the central control unit, and the external OTG device supplies power to the central control unit via the OTG self-holding circuit module under the master mode.

10. The method of the automatic USB identification and communication system with a star architecture as claimed in claim 9, characterized in that, in Step b, the central control unit determines the condition of connection between the master port and a master device as well as between the USB OTG port and an OTG device based on the tested potentials of the master power supply pin of the master port and the OTG ID pin of the USB OTG port, and the state of the OTG data pin, and controls the power supply circuit module and the data communication module to communicate with any two of the master port, the slave port and the USB OTG port.

11. The method of the automatic USB identification and communication system with a star architecture as claimed in claim 10, characterized in that in Step b, if the central control unit determines that the master port connects a master device and the USB OTG port connects an OTG device, the central control unit will connect the master port and the USB OTG port; if the central control unit determines that the master port connects a master device and the USB OTG port is not connected to an OTG device, the central control unit will connect the master port and the slave port; if the master port is not connected to a master device and the USB OTG port connects an OTG device, the OTG device will be shifted to the master mode via the OTG self-holding circuit and supply power to the central control unit; if the central control unit determines that the master port is not connected to a master device and the USB OTG port connects an OTG device, it will connect the USB OTG port and the slave port.

12. The method of the automatic USB identification and communication system with a star architecture as claimed in claim 10, characterized in that, after Step b it also includes:
c. if the central control unit tests that the potentials of the master power supply pin of the master port and the OTG ID pin of the USB OTG port, and the state of the OTG data pin have changed, the central control unit will cut off the connection between the master port, the slave port and the USB OTG port and wait for a while, and then return back to Step b.

13. The method of the automatic USB identification and communication system with a star architecture as claimed in claim 11, characterized in that, after Step b it also includes:
c. if the central control unit tests that the potentials of the master power supply pin of the master port and the OTG ID pin of the USB OTG port, and the state of the OTG data pin have changed, the central control unit will cut off the connection between the master port, the slave port and the USB OTG port and wait for a while, and then return back to Step b.

14. (New, 7): The automatic USB identification and communication system with a star architecture as claimed in claim 2, characterized in that it is provided with several slave ports which are integrated together.

15. (New, 7): The automatic USB identification and communication system with a star architecture as claimed in claim 3, characterized in that it is provided with several slave ports which are integrated together.

16. (New, 7): The automatic USB identification and communication system with a star architecture as claimed in claim 4, characterized in that it is provided with several slave ports which are integrated together.

17. (New, 7): The automatic USB identification and communication system with a star architecture as claimed in claim 5, characterized in that it is provided with several slave ports which are integrated together.

18. (New, 7): The automatic USB identification and communication system with a star architecture as claimed in claim 6, characterized in that it is provided with several slave ports which are integrated together.
